(19) United States
(12) Patent Application Publication
(10) Pub. No.: US 2011/0198328 A1
(43) Pub. Date: Aug. 18, 2011

(54) Welding-Type System With USB Host

(75) Inventor: Bruce A Casner, Neenah, WI (US)

(73) Assignee: Illinois Tool Works Inc., Glenview, IL (US)

(21) Appl. No.: 12/963,697

(22) Filed: Dec. 9, 2010

Related U.S. Application Data
(60) Provisional application No. 61/303,721, filed on Feb. 12, 2010.

(51) Int. Cl. B23K 9/12

(52) U.S. Cl. 219/125.1

(57) ABSTRACT

A method and apparatus for providing welding-type power is disclosed and includes a USB host and/or non-volatile memory, for example, an SD card and a memory stick. The controller preferably includes a receptacle for receiving a USB flash drive according to one embodiment. The controller can include one or more of a data monitoring module, a data logging module, a data logging module for providing diagnostic data, a code update module, an IP address logging module, disposed to provide data to the USB flash drive or non-volatile memory, according to various embodiments.

### FIELD OF THE INVENTION

The present invention relates generally to the art of welding-type power supplies. More specifically, it relates to a welding-type power supply with a USB Host or other multi-use data connection.

### BACKGROUND OF THE INVENTION

There are many known welding-type systems used to provide a welding-type output or welding-type power for many known applications. Welding-type system, as used herein, includes any device capable of supplying welding, plasma cutting, and/or induction heating power including convertors, invertors, choppers, resonant power supplies, quasi-resonant power supplies, etc., as well as control circuitry and other ancillary circuitry associated therewith. Welding-type output, as used herein, includes outputs suitable for welding, plasma or heating. Welding type power, as used herein, refers to welding, plasma or heating power.

Examples of prior art welding-type systems include those described in Method of Designing and Manufacturing Welding-Type Power Supplies, Albrecht, filed Sep. 19, 2001, application Ser. No. 09/956,401, which issued on Mar. 30, 2004 as U.S. Pat. No. 6,713,721; Pendant Control for a Welding-Type System, L. Thomas Hayes, filed Sep. 19, 2001, application Ser. No. 09/956,502, which issued on Oct. 28, 2003 as U.S. Pat. No. 6,639,182; Welding-Type Power Supply With A State-Based Controller, Holverson et al, filed Sep. 19, 2001, application Ser. No. 09/956,548, which issued on Jun. 8, 2004 as U.S. Pat. No. 6,747,247; Welding-Type System With Network And Multiple Level Messaging Between Components, Davidson et al., filed Sep. 19, 2001, application Ser. No. 09/957,707, which issued on Dec. 30, 2003 as U.S. Pat. No. 6,670,579; Welding-Type Power Supply With Boot Loader, L. Thomas Hayes, filed Sep. 19, 2001, application Ser. No. 09/956,405, which issued on Jan. 7, 2003 as U.S. Pat. No. 6,504,131; and Welding-Type System With Robot Calibration, Rappl et al., filed Sep. 19, 2001, application Ser. No. 09/956,501, which issued on Nov. 4, 2003 as U.S. Pat. No. 6,642,482. Each of these patents is hereby incorporated by reference.

Some systems include sophisticated programming and/or data monitoring. Prior art welding-type system use a serial port to provide updates to the system, via a smart handheld device in the past. However, a more convenient method is desired. It is desirable to provide such systems with a way to connect non-volatile memory to store data and/or provide data/programming to the welding-type system, and/or a printer, and/or other devices. Accordingly, a welding-type system that includes a multi-use data connection is desired.

### SUMMARY OF THE PRESENT INVENTION

According to one aspect of the invention a welding-type system includes a source of power and a controller. The controller includes a USB host.

According to another aspect of the invention a welding-type system includes a non-volatile, removable memory.

According to a third aspect of the invention a method of storing data related to a welding type system includes providing a controller for the welding type system with a USB host, or other non-volatile memory, and monitoring data related to the welding type system, and writing the data to a USB drive or other non-volatile memory that is part of the welding type system.

The controller includes a receptacle for receiving a USB flash drive according to one embodiment.

The non-volatile memory includes one or more of an SD card and a memory stick, according to various embodiments.

The controller includes one or more of a data monitoring module, a data logging module, a data logging module for providing diagnostic data, a code update module, an IP address logging module, disposed to provide data to the USB flash drive or non-volatile memory, according to various embodiments.

Writing data includes writing a real time clock value according to one

Other principal features and advantages of the invention will become apparent to those skilled in the art upon review of the following drawings, the detailed description and the appended claims.

### BRIEF DESCRIPTION OF THE DRAWINGS

FIG. 1 is a welding-type system in accordance with the preferred embodiment of the present invention;

FIG. 2 is block diagram in accordance with the preferred embodiment of the present invention; and

FIG. 3 is block diagram of a controller in accordance with the preferred embodiment of the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular welding-type system it should be understood at the outset that the USB host can also be implemented with other welding-type systems.

The preferred embodiment provides for implementing the invention with the Miller Axcess® welding power supply. The Axcess® controller can include a weld data logging and/or monitoring module for weld data monitoring and/or logging and/or a real time clock in the preferred embodiment. The preferred embodiment provides that the welding-type system include a USB host.

The USB host is the preferred connection, because of its widespread use, although other type of connections may be used. The USB host allows the welding-type system to communicate with a storage device, a printer, or any other number of USB connected devices. For example, the USB host can be used to update code in the welding-type system by inserting a USB flash drive and powering up the machine, using a code update module connected to the USB drive. It can also be non-volatile memory (via a USB flash drive) for storing monitoring data. Another use of the USB flash drive is to store diagnostic logs, databases, and data, such as information on error returns from procedure calls, program diagnostics etc, using the data logging module. The USB flash drive can be removed for remote access such as for extended diagnostic analysis. This may be particularly useful if the welding-type system is not connected to a network. It also allows automatic configuration of optional wireless network connections, and can be used to save the IP addresses of the machine from an IP address logging module for IP address discovery. A USB host can also allow connection of a printer, plotter, etc to record information. It can also be used for connection of future NDIS compatible network access.

USB Host hardware is well known, and can readily be incorporated into personal computers. Implementing the USB Host function into a welding-type system preferably includes incorporation of an Operating System (OS) capable of supporting multiple USB Host Profiles into the welding machine. The welding application code may then be created to run on the Operating System. The OS is preferably an off-the-shelf OS.

Advantages of using a USB host in a welding-type system include no longer requiring the owner of the system to maintain proprietary pendants or smart handheld devices to update software, because they can use USB Flash drives that are low cost and readily available. Also, no complex action is required to update or upgrade the welding application or processors.

Alternatives include using SD, memory stick, or other similar cards for code updates and non-volatile memory. Another alternative for data printing includes using a serial connection for printing.

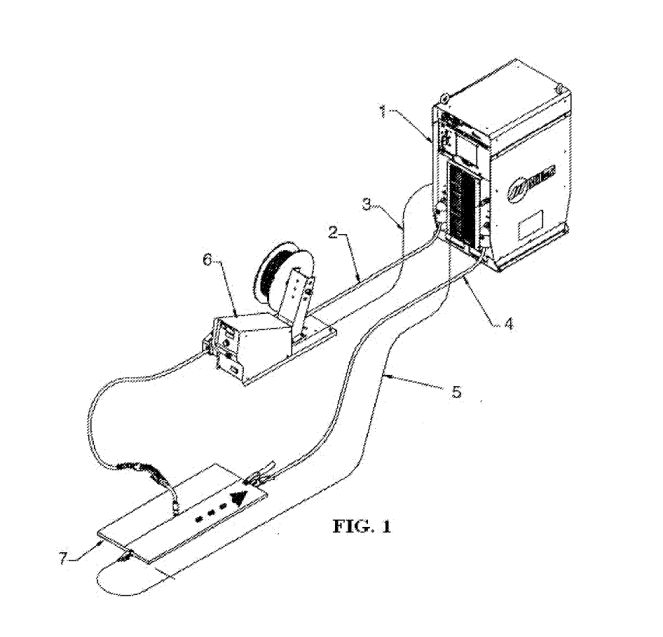

Referring to FIG. 1, a welding-type system 100 includes a power supply 1, and a wire feeder 6, which cooperate to provide power over a pair of weld cables 2 and 4 to a workpiece 7. Feeder cable 3 and a voltage sense cable 5 are used for control/feedback. The system shown is an Axcess® or Axcess E® welding system, but the invention may readily be implemented with other welding-type systems. Welding system 100 performs generally as prior art welding systems, but includes a USB host for connecting a USB device to system 100. System 100 may also include advanced data monitoring and logging, including time tagging data.

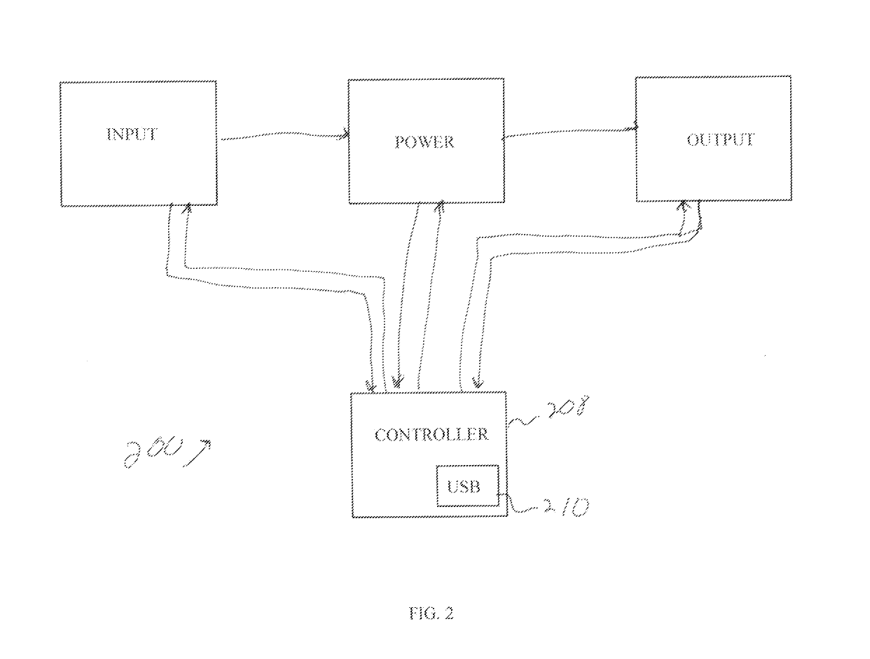

Referring now to FIG. 2, a diagram shows a welding-type system 200 includes an input circuit 202, a power circuit 204, and an output 206, as well as a controller 208. Circuits 202, 204 and 206, and controller 208, are part of welding power supply 1 (FIG. 1) in the preferred embodiment. They are distributed over several locations (such as wire feeder 6, an external control circuit, etc.) in other embodiments. Circuits 202, 204 and 206, and controller 208 are functional blocks and need not be physically distinct circuits.

Circuits 202, 204 and 206, are, in one embodiment, consistent with those shown in U.S. Pat. No. 6,329,636, entitled Method And Apparatus For Receiving A Universal Input Voltage In A Welding, Plasma Or Heating Power Source, issued Dec. 11, 2001, which is hereby incorporated by reference. Accordingly, circuits 202, 204 and 206 may include circuitry to rectify, boost, power factor correct, invert and transform different input powers into welding-type power.

Controller 208 includes much of the control circuitry of the prior art, including that used to turn switches on and off circuits 202, 204 and 206. This switch control circuitry can be implemented with other control circuitry, including digital, analog, and include micro processors, DSPs, analog circuitry, etc. Also, controller 208 preferably includes circuitry to monitor and/or log operating date, and for providing that data to the USB drive.

In accordance with the invention a USB host 210 is used to provide a USB port for connecting USB devices to controller 208. USB host 210 is preferably a commercially USB host, and includes the software necessary to operate. The OS may be part of controller 208, USB host 210, or located elsewhere. Other alternatives include USB host 210 being part of an off-the-shelf computer, or a custom made USB host circuit with standard or custom software.

In operation controller 208 includes the OS, and when a USB flash drive is inserted into USB host 210, the OS recognizes the drive, and can “auto play” a data update, data recording, print program, etc. The flash drive could include self-contained portable apps, or require code to be in controller 208, or elsewhere, including on a network.

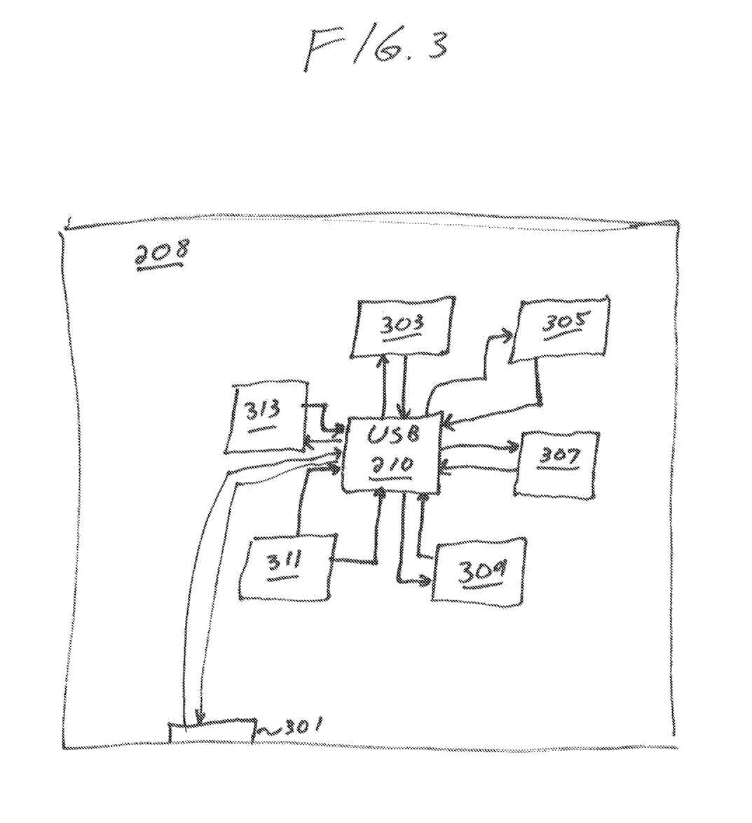

Controller 208 is shown in FIG. 3 to include a USB receptacle 301, a data monitoring module 303, a data logging module 305, a data logging module 307, code update module 309, an IP address logging module 311 and an off-the shelf operating system 313.

USB receptacle 301 is preferably an off-the-shelf receptacle, and is, in alternative embodiments, a receptacle for other non-volatile memory such as SD, memory stick, etc. Receptacle 301 communicates with host 210.

Data monitoring module 303 is disposed to provide data to and receive data from USB host 210. Data monitoring module 303 is software and/or hardware that functions to monitor and provide data.

Data logging module 305 is disposed to provide data to USB host 210. Data logging 305 is software and/or hardware that functions to log data that has been monitored or fed back. Data logging module 307 is disposed to provide diagnostic data to the USB flash drive, and can be separate from or part of data logging module 305. Data logging 307 is software and/or hardware that functions to monitor and provide data.

Code update module 309 is disposed to receive a code update from USB host 210. Code update module 309 is software and/or hardware that functions to monitor and provide data.

IP address logging module 311 is disposed to receive a code update from USB host 210. IP address logging module 311 is software and/or hardware that functions to log the IP address, and is preferably used data logging modules 305 and 307.

Various alternatives provide that welding-type system 100 includes network communication, such as WAN, LAN, over power lines, over a smart grid, and that the data transmitted and/or stored, such as on a USB drive, include arc parameters and primary information, such as harmonics data, utilization data, etc. The information can be shared over the network or using a drive with end users, power companies, manufacturers that use welders, manufactures that supply welders, etc. Additionally, various alternatives and arrangement are shown in the attached appendix.

Numerous modifications may be made to the present invention which still fall within the intended scope hereof. Thus, it should be apparent that there has been provided in accordance with the present invention a method and apparatus for a welding-type system with a USB host and/or a non-volatile memory that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A welding-type system including a source of power, a controller connected to the source of power, wherein the controller includes a USB host.

2. The welding-type system of claim 1, wherein the controller includes a receptacle for receiving a USB flash drive.

3. The welding-type system of claim 2, wherein the controller includes a data monitoring module, disposed to provide data to the USB flash drive.

4. The welding-type system of claim 2, wherein the controller includes a data logging module, disposed to provide data to the USB flash drive.

5. The welding-type system of claim 2, wherein the controller includes a data logging module, disposed to provide diagnostic data to the USB flash drive.

6. The welding-type system of claim 2, wherein the controller includes a code update module, connected to receive code updates from the USB flash drive.

7. The welding-type system of claim 2, wherein the controller includes an IP address logging module, disposed to provide an IP address to the USB flash drive.

8. The welding-type system of claim 2, wherein the controller includes an off-the shelf operating system.

9. A welding-type system including a source of power, a controller connected to the source of power, wherein the controller includes a non-volatile, removable memory.

10. The welding-type system of claim 9, wherein the non-volatile memory includes at least one of an SD card and a memory stick.

11. The welding-type system of claim 9, wherein the controller includes a data monitoring module, disposed to provide data to the non-volatile memory.

12. The welding-type system of claim 9, wherein the controller includes a data logging module, disposed to provide data to the non-volatile memory.

13. The welding-type system of claim 9, wherein the controller includes a data logging module, disposed to provide diagnostic data to the non-volatile memory.

14. The welding-type system of claim 9, wherein the controller includes a code update module, connected to receive code updates from the non-volatile memory.

15. The welding-type system of claim 9, wherein the controller includes an IP address logging module, disposed to provide an IP address to the non-volatile memory.

16. The welding-type system of claim 9, wherein the controller includes an off-the shelf operating system.

17. A method of storing data related to a welding type system including providing a controller for the welding type system that includes a USB host, monitoring data related to the welding type system, and writing the data to a USB drive that is part of the welding type system.

18. The method of claim 17, wherein monitoring data includes monitoring diagnostic data.

19. The method of claim 17, wherein writing the data includes writing a real time clock value.

20. The method of claim 17, wherein writing includes writing an IP address to the USB flash drive.

21. A method of updating code for a welding type system including reading a code update from the USB drive that is part of the welding type system, and updating the welding type system in response to the reading.

22. A method of storing data related to a welding type system including providing a controller for the welding type system that includes a nonvolatile removable memory, monitoring data related to the welding type system, and writing the data to the nonvolatile removable memory.

23. The method of claim 22, wherein monitoring data includes monitoring diagnostic data.

24. The method of claim 22, wherein writing the data includes writing a real time clock value.

25. The method of claim 22, wherein writing includes writing an IP address to the nonvolatile removable memory.
